(19) United States
(12) Patent Application Publication
(10) Pub. No.: US 2017/0307039 A1
(43) Pub. Date: Oct. 26, 2017

(54) LEAF SPRING, PARTICULARLY FOR ARTICULATED MECHANICAL STRUCTURES

(71) Applicant: SPECIALITIES S.R.L., Loc. Ponte Giurino (IT)

(72) Inventor: Francesco COZZO, Pettenasco (IT)

(21) Appl. No.: 15/523,490

(22) PCT Filed: Oct. 28, 2015
(86) PCT No.: PCT/IB2015/058309

§ 371 Date: May 1, 2017

(30) Foreign Application Priority Data
Oct. 29, 2014 (IT) MI2014A001851

(51) Int. Cl. F16F 1/368; B60G 11/12; F16F 1/36

(52) U.S. Cl. CPC F16F 1/3683; B60G 11/12; F16F 2224/0241; F16F 1/3615

(57) ABSTRACT

A leaf spring, particularly for articulated mechanical structures, includes at least one longitudinally extended elastic element and a pair of rigid elements which are configured to be associated with an articulated mechanical structure. Each one of the rigid elements is coupled rigidly, at a first end thereof, to a respective end of the elastic element. The elastic element is not associated with any constraint or load between its two ends.

### TECHNICAL FIELD

The present disclosure relates to a leaf spring, with high energy accumulation, particularly for articulated mechanical structures.

### BACKGROUND

Conventional mechanical energy storage devices, comprised in the category of mechanical springs, are characterized, in general, by the type of stress that they induce in the elastic element designed for the purpose of accumulating and returning energy. In particular, such stresses can be bending, torsion, or tensile.

Mechanical springs that respond to bending stresses can have the following configurations: simple leaf, interlocked and/or resting at one end or at both ends, multiple leaves, such as for example laminated leaf springs, or coil springs wound in an Archimedean spiral with interlocked ends, and coil springs wound in a cylindrical helix, also interlocked at the ends.

Leaf springs and laminated leaf springs are generally used to accumulate and return energy originating from forces acting substantially perpendicular to the bending surface, while coil springs are generally used to accumulate and return energy originating from torque moments in the bending plane.

The aforementioned springs are configured to take advantage of the stiffness of the material, in that the bending stress is a combination of the tensile and compression stresses, which are the maximum stresses typical of the stiffness of the materials.

However, the limitation of such conventional leaf springs and laminated leaf springs is represented, in general, by the consequences related to the elastic deformation that they undergo during their operation, in that they must always allow sliding or movements which are not always congruous with the couplings of at least one constrained end.

In particular, a limitation of these conventional mechanical springs is due to the fact that the loads or the couplings are applied directly on them, in particular along their inflection length, such that the latter is limited, as a minimum, to half thereof.

Also, the typical arrangement of such springs, such as in their principal use which is as laminated leaf spring suspensions of vehicles, is characterized by the direct anchoring thereon of the load that induces the bending therein, or of the necessary supports, thus limiting the mechanical arrangement to a beam resting and free to rotate at one end and resting and free to rotate and/or slide at the other end, with a load concentrated in or near the center.

We know from building science that such a mechanical arrangement induces a non-uniform distribution of the stresses, derived from the bending moment and/or from shear, along the free length of inflection, almost always calls for non-constant cross-sections of the spring in order to optimize its behavior.

We also know that the deflection or camber is limited by such mechanical arrangement and, setting aside the forces in play and the length of the beam, as well as the geometric inertia of the cross-section of the spring and the stretch modulus of the material that constitutes it, it varies as a function of a number represented by the ratio of 1/48.

In order to overcome this drawback, sometimes the load is applied directly at one end of the spring, while the supports that join it rigidly to the structures to be cushioned, in particular along its longitudinal extension, are still fixed to it.

In such case the inflections can increase, again irrespective of the loads, the geometric inertia of the cross-section, and the stretch modulus of the material that makes up the spring, up to a number equal to 1/3.

Unfortunately however the free lengths become very small and the shear stresses, as with the inflection curve, are maximal. In particular, the shear stresses are maximal, equal to the applied load, up until the first support, and then are inverted in sign, but without ever becoming nil.

Furthermore, the distribution of the forces originating from the bending moment is not uniform along the free length of inflection, again making it necessary to have non-constant cross-sections of the spring in order to optimize its behavior.

An example of such type of spring belonging to the known art is shown in EP1120298.

The operation of such conventional springs is usually not reversible, i.e. such springs are adapted to work only along one direction of applied forces and the consequent deformation.

Mechanical springs that respond to torsion stresses can have the following configurations: a bar, and a wound coil in a cylindrical helix or conical spiral.

A mechanical bar spring, usually tubular or solid in cross-section, is interlocked at its ends. Such couplings transmit a torque and corresponding shear flows along the axis of the spring. Such mechanical spring has the characteristic of allowing the reversibility of the applied forces and corresponding deformations but, with regard to conservation of cross-section geometry, it suffers from the drawback of necessitating couplings that can slide along the axis of the spring.

Mechanical coil springs, on the other hand, through helical coil geometry, convert normal forces applied to the coiling axis of that geometry to torsion. These conventional springs, although they undergo congruous deformations along the axis of the forces applied, do not offer characteristics of reversibility of such forces.

In general, as is known from materials science, in terms of ratio of stiffness, shear stress is approximately 1/3 lower than bending stress.

Despite the fact that the Young's modulus also decreases, multiplying by Poisson's ratio, by about the same amount, conventional mechanical springs that respond to torsion stresses still suffer the drawback, with respect to conventional mechanical springs that respond to bending stresses, of less stiffness and as a consequence less efficiency with respect to the amount of energy accumulated, although they do exhibit, in general, fewer geometric encumbrances and the possibility of increasing the extension and, as a consequence, the free length of inflection, in this manner being able to accumulate more energy in the form of mechanical deformation.

With regard to purely tensile stress, the shape of the mechanical spring used is constituted by a mono-axial element with a very small cross-section, such as a cord or a wire, or possibly even by a flat element. For straight cables or cords, the only force allowed in order to induce purely tensile stress is directed along the axis of the cables or cords, while for flat elements the forces are perpendicular to their plane of arrangement and, owing to their inertial characteristics, induce, in general, only tensile stresses in their membrane-like behavior. For the former, it is not possible to reverse the forces, while for the latter it is possible, but given the low (in terms of value) inertial characteristics, they do not have the capacity to withstand high stresses unless they are paired, as happens for example in trampolines, with other springs, in this example wound coil springs, which convert, through the extension of the helices, the membrane forces of the flat element to torsion stresses as previously described above.

Generally, the materials used for making springs are materials of the type of metal or even polymeric composites, which in any case have a high stretch modulus (Young's modulus) and a high stiffness while never exceeding, in any case, a ratio of the latter (in MPa) to the former (in GPa) which is equal to about 5 up to a maximum of 10.

For this reason, such materials are not always adapted to efficiently accumulate the elastic energy to which they are subjected, even in relation to the geometries, stresses and configurations of the various mechanical springs described above.

As is known, in recent years new composite materials have been developed, and moreover without changing the geometry or the operating arrangement, which are adapted to increase the performance levels of the various systems described, in particular with reference to reduction of mass.

### SUMMARY

The aim of the present disclosure is to provide a spring that can overcome the various drawbacks of the known art mentioned above, in terms of efficacy, simplicity of use and applicability.

Within this aim, the present disclosure provides a leaf spring, or an accumulator of energy in the form of mechanical deformation, for purely tensile stresses, which is highly efficient, which can be associated with the most widely differing planar and non-planar articulated systems, two-dimensional or three-dimensional, and which can work in parallel and not in series with respect to the loads and couplings that induce the deformation thereof.

In such case, such deformation, and the consequent accumulation and possible return of mechanical energy make it possible to provide articulated systems, including systems that are very complex, but still isostatic, capable of precisely controlling the translations, linear or angular, of the elements that induce the loads or with which the loads are associated.

The disclosure further provides a leaf spring the rigidity of which is adjustable, not only with respect to the total bending moment but also by conditioning the peak point thereof, as a function of the type of response to the load which it is desired to obtain.

The disclosure also provides a leaf spring that has characteristics of reversibility, i.e. which is capable of executing the same work for loads with the direction inverted.

The disclosure provides a leaf spring that can be associated with the most varied, different and complex mechanical structures.

The disclosure further provides a leaf spring that has a high efficiency of energy accumulation and which can be used to absorb shocks, to enhance or reduce vibrational effects, to reposition machine elements, and to accumulate, conserve and return elastic energy.

The disclosure also provides a spring characterized by a very high ratio of accumulated energy with respect to its weight, therefore in general very light and very efficient.

The present disclosure further provides a leaf spring that is highly reliable, for both static and dynamic loads and also for fatigue stress loads, is easily and practically implemented, and is low cost.

These features which will become better apparent hereinafter are achieved by providing a leaf spring, particularly for articulated mechanical structures, which comprises at least one longitudinally extended elastic element, characterized in that it comprises a pair of rigid elements which are configured to be associated with an articulated mechanical structure, each one of said rigid elements being coupled rigidly, at a first end thereof, to a respective end of said elastic element, and comprising, at a second end thereof, means of coupling to said articulated mechanical structure, which have a hinge-like coupling, said elastic element not being associated with any constraint or load between the two said ends.

In a preferred embodiment, the loads and/or the couplings that can induce, in such elastic element, a bending in its preferential plane of deformation, can therefore be transferred to it only by a pair of elements with greater rigidity, preferably at least five times greater, than the rigidity of the elastic element, which are configured to be associated with an articulated mechanical structure by way of one end provided with hinge-like couplings, each one of such rigid elements being rigidly coupled, at the opposite end, to a respective end of the elastic element.

The loads and/or the couplings cannot therefore be associated rigidly with the elastic element except at the ends of that elastic element. In more detail, in the leaf spring according to the disclosure, the loads and/or the couplings that can induce or condition a bending therein, or connect it to mechanical parts, cannot be fixed in any way to the elastic element, it being possible for such loads and/or couplings to be transferred and/or represented only by a pair of elements that are rigidly coupled, at one end thereof, to a respective end of the elastic element.

### BRIEF DESCRIPTION OF THE DRAWINGS

Further characteristics and advantages of the disclosure will become better apparent from the description of a preferred, but not exclusive, embodiment of the leaf spring according to the disclosure, which is illustrated by way of non-limiting example in the accompanying drawings wherein:

FIG. 1 is a perspective view of a leaf spring according to the disclosure;

FIG. 2 is a side view of the leaf spring in FIG. 1;

FIGS. 2a and 2b show two different states of deformation of the leaf spring in FIG. 1;

FIG. 3 is an exploded perspective view of the leaf spring in FIG. 1;

FIG. 4 is a side view of a first variation of the leaf spring according to the disclosure;

FIG. 5 is a perspective view of a second variation of the leaf spring according to the disclosure;

FIG. 6 is a perspective view of a third variation of the leaf spring according to the disclosure;

FIG. 7 is a side view of the leaf spring in FIG. 6;

FIG. 8 is a perspective view of a fourth variation of the leaf spring according to the disclosure;

FIG. 9 is a side view of the leaf spring in FIG. 8;

FIG. 10 is a perspective view of a fifth variation of the leaf spring according to the disclosure, applied to a telescopic articulated mechanical structure;

FIGS. 10a and 10b show two different states of deformation of the leaf spring in FIG. 10;

FIG. 11 is a perspective view of a sixth variation of the leaf spring, according to the disclosure, applied to an articulated polygon mechanical structure;

FIG. 12 is a side view of the leaf spring in FIG. 11;

FIG. 12a shows the leaf spring in FIG. 11 in two different states of deformation;

FIG. 13 is a perspective view of a seventh variation of the leaf spring, according to the disclosure, applied to a different articulated polygon mechanical structure;

FIG. 14 is a side view of the leaf spring in FIG. 13; and

FIGS. 15 and 16 are respectively a perspective view and a front elevation view of an elastic articulated mechanical system that comprises a plurality of leaf springs, according to the disclosure.

### DETAILED DESCRIPTION OF THE DRAWINGS

With reference to the figures, the leaf spring, particularly for articulated mechanical structures, is generally designated by the reference numeral 1 and comprises at least one longitudinally-extended elastic element 5.

According to the disclosure, the leaf spring 1 comprises a pair of rigid elements 7 which are configured to be associated with an articulated mechanical structure 3. Each one of the rigid elements 7 is rigidly coupled, at a first end 9 thereof, to a respective end 13, 15 of the elastic element 5. Furthermore, the rigid elements 7 comprise, at a second end 11 thereof, which is opposite to the first end 9, means for coupling to the articulated mechanical structure 3, by way of a hinge-like coupling 17.

The rigid coupling between the rigid elements 7 and the elastic element 5 is an interlocking coupling.

Advantageously, furthermore, at least one rigid element 7, and preferably both, comprises means 19 for adjusting the distance between the rotation axis of the means for mating with a hinge-like coupling 17 and the point at which the rigid element 7 is rigidly coupled to the elastic element 5.

The elastic element 5 is advantageously made of a material that has a ratio of the bending breakage resistance (R), expressed in MPa, to the Young's stretch modulus (E), expressed in GPa, along the direction of the plane of deformation, not less than 20.

Such material is advantageously a composite material with a thermoplastic, or thermosetting, matrix, preferably reinforced with monoaxial fibers or unbalanced fabrics, obtained using methods of production such as pultrusion, press or autoclave molding, or injection molding.

The rigid elements 7 are preferably made of a material or in a shape which has a bending rigidity that is at least five times the bending rigidity of the elastic element 5 relative to its preferential bending plane.

The rigidity can be expressed as the product E×J for the stretch modulus (E) and for the moment of geometric inertia (J), around the longitudinal axis of the rigid element 7. Such characteristic is necessary in order to best induce the bending of the elastic element 5, while minimizing parasitical bending moments of the rigid elements 7 which would diminish the transfer (for which they are designed) of the bending load to the elastic element 5.

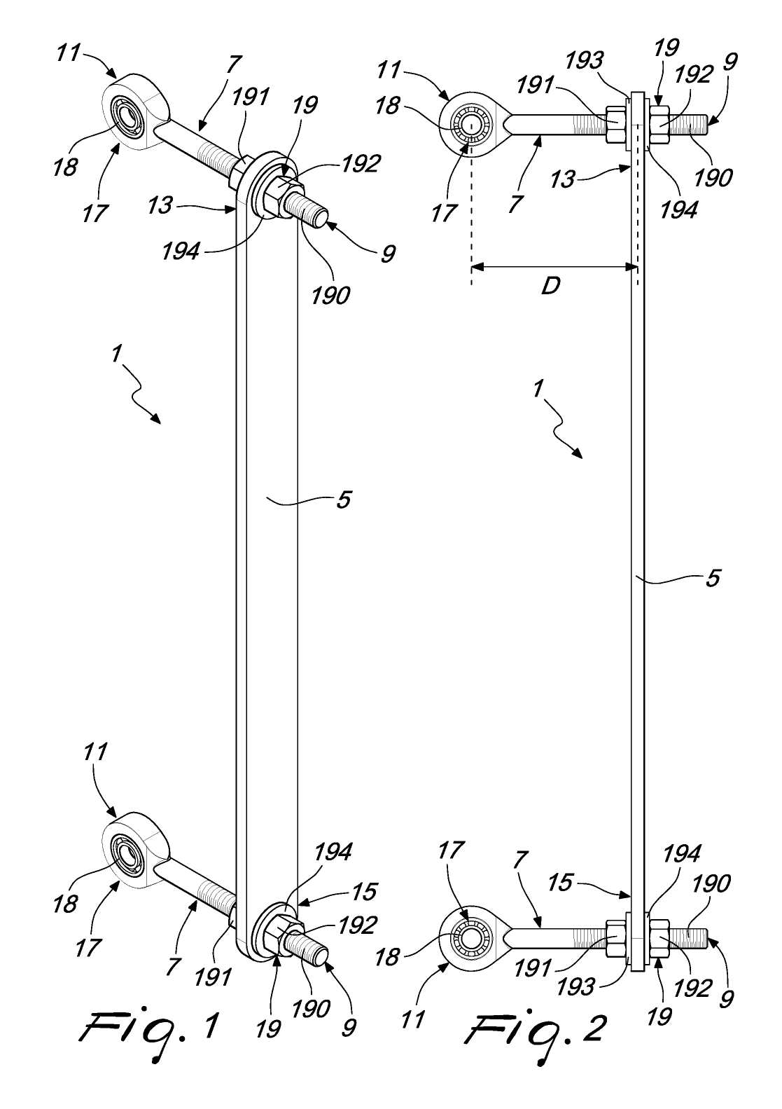

In the embodiment of the leaf spring 1 shown in FIG. 1, the rigid elements 7 extend perpendicularly with respect to the longitudinal extension of the elastic element 5.

In the first variation of the leaf spring 1, shown in FIG. 4, the rigid elements 7 extend at an angle, greater than or less than 90°, with respect to the longitudinal extension of the elastic element 5.

The central portion of the elastic element 5 can have an increased transverse cross-section with respect to the transverse cross-section of the end portions 13, 15 of the elastic element 5, in order to optimize the distribution of the stresses in particular cases, such as for example cases relating to differences between the lengths of the rigid elements 7.

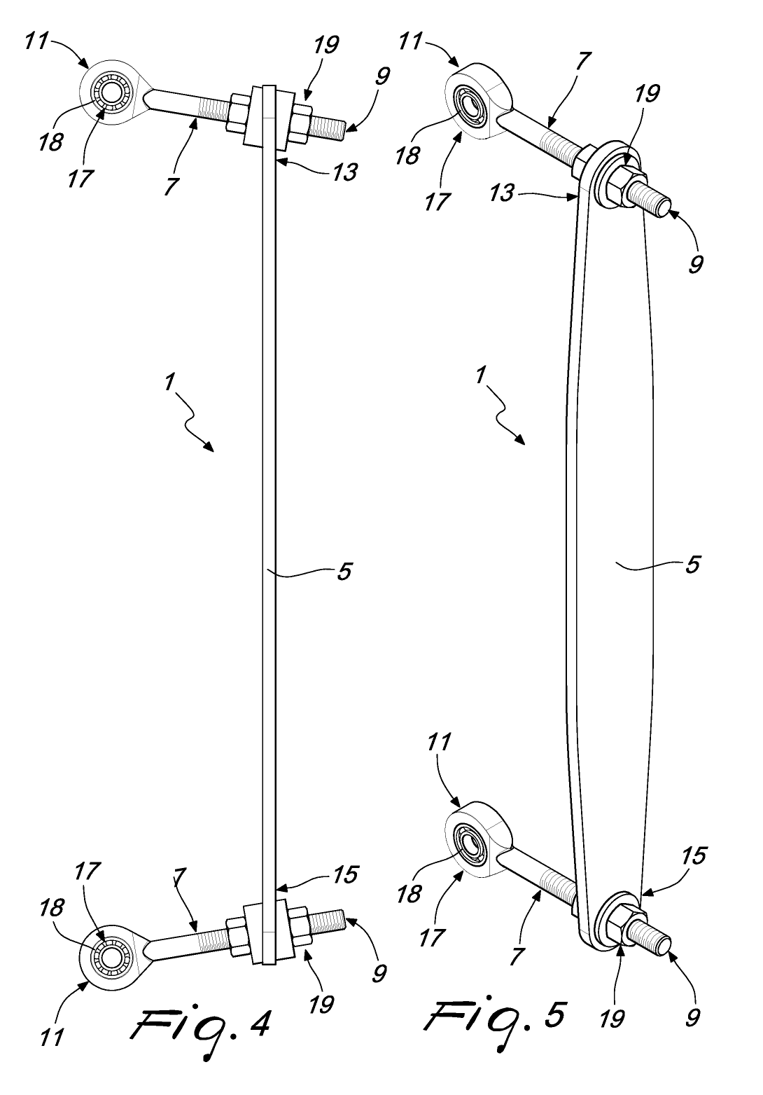

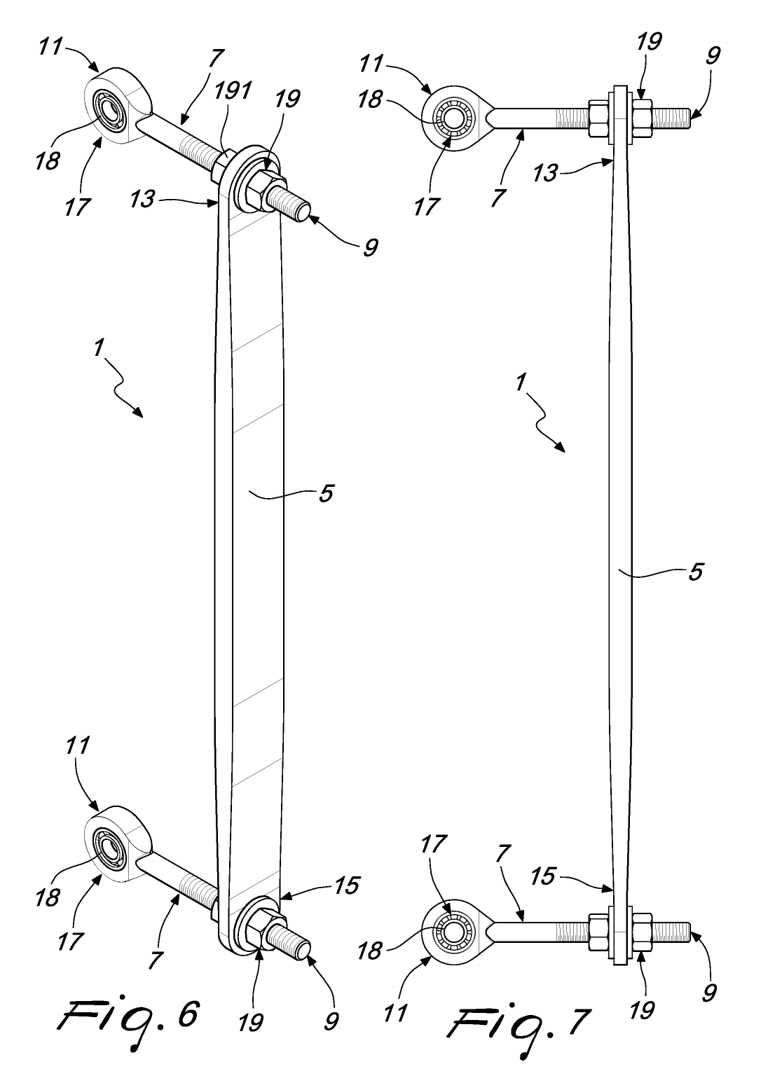

In particular, in the second and in the third variations of the leaf spring 1 shown respectively in FIGS. 5 and 6, the area of the transverse cross-section of the elastic element 5, in its central portion, is greater than the area of the transverse cross-section of the end portions 13 and 15 of that elastic element. The elastic element 5 can in fact have a non-constant cross-section both on the plane of arrangement and on the plane perpendicular thereto.

The means for mating with a hinge-like coupling 17 are advantageously selected from the group constituted by ball bearing hinges 18, bushing hinges, barrel hinges and spherical hinges. The coupling means 17 can in fact be rotatable about a fixed planar axis, such as with bearings or bushings, or three-dimensional, such as with spherical joints.

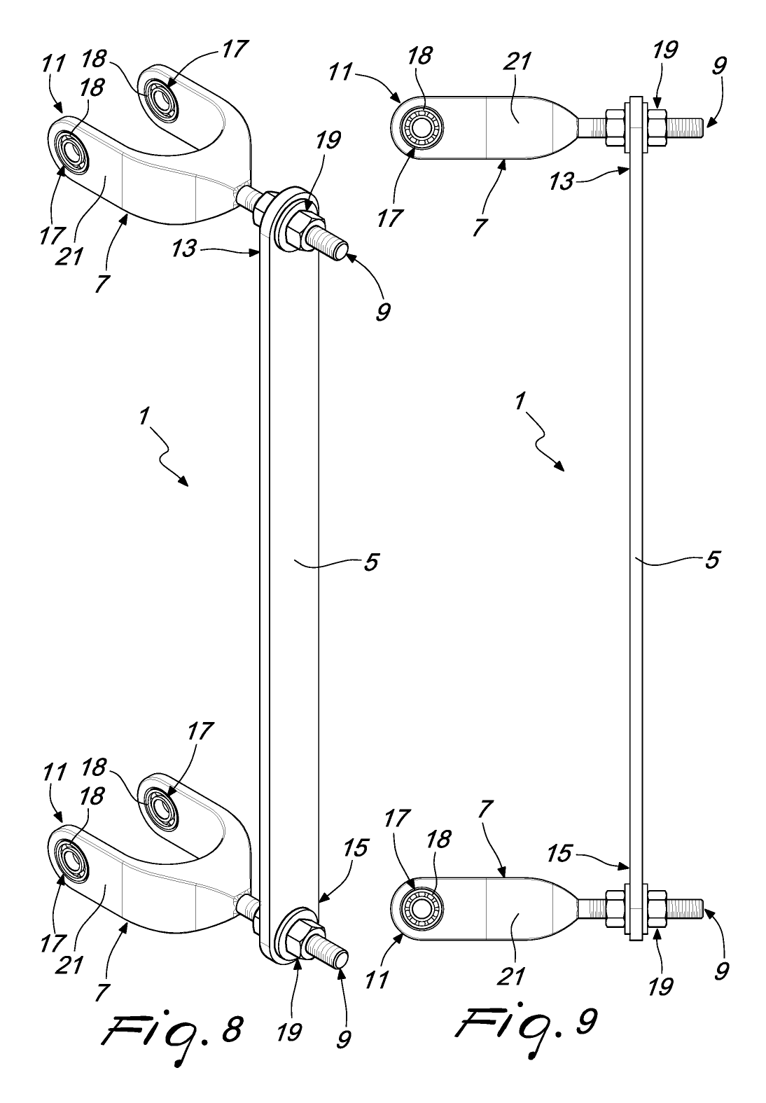

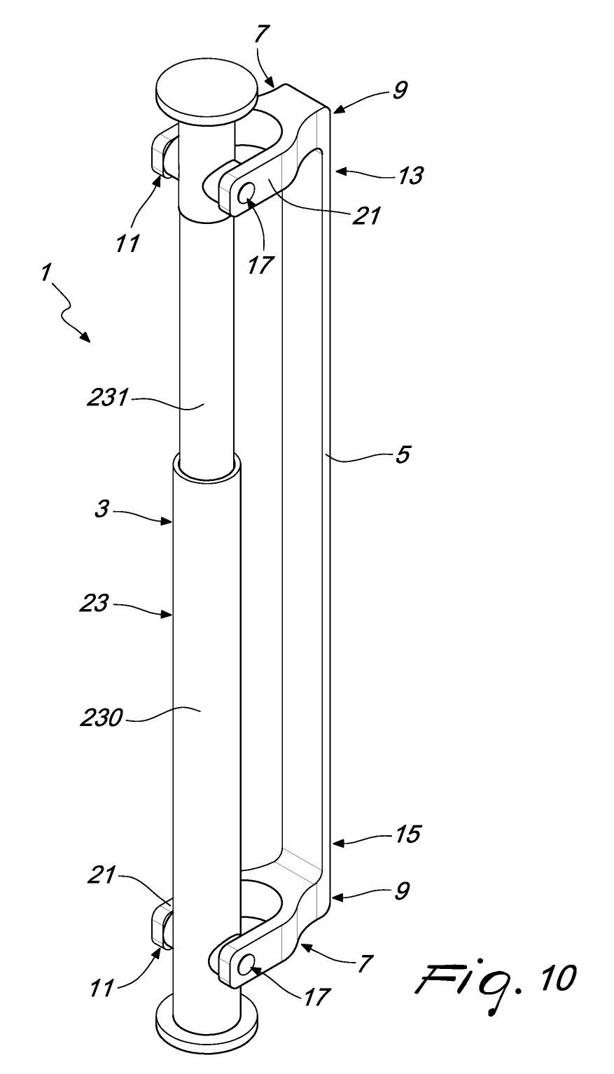

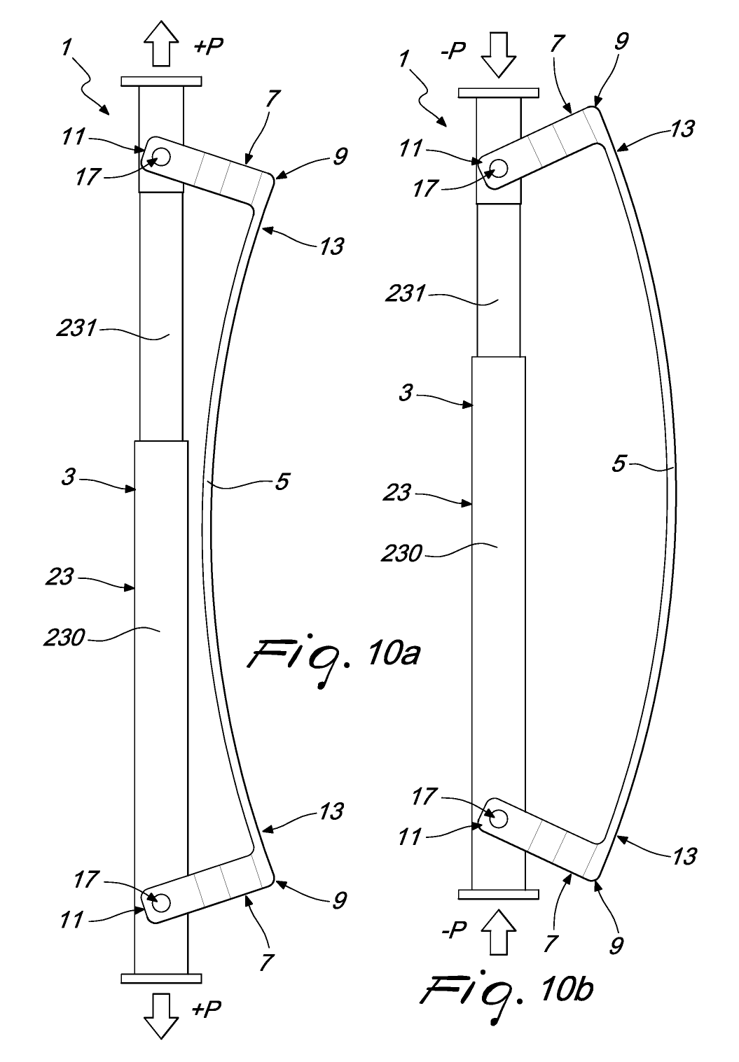

The rigid element 7, as illustrated in the variations shown in FIGS. 8 and 10, can comprise a fork 21, provided with a pair of bearings 18 or with a pair of rotating joints.

The rigid connection between the ends 9 of the rigid elements 7 and the elastic element 5 can be defined by adhesive resins, co-molding processes, nuts, or other fixing elements that are capable of ensuring the transmission of the maximum breaking torque upon bending of the elastic element 5.

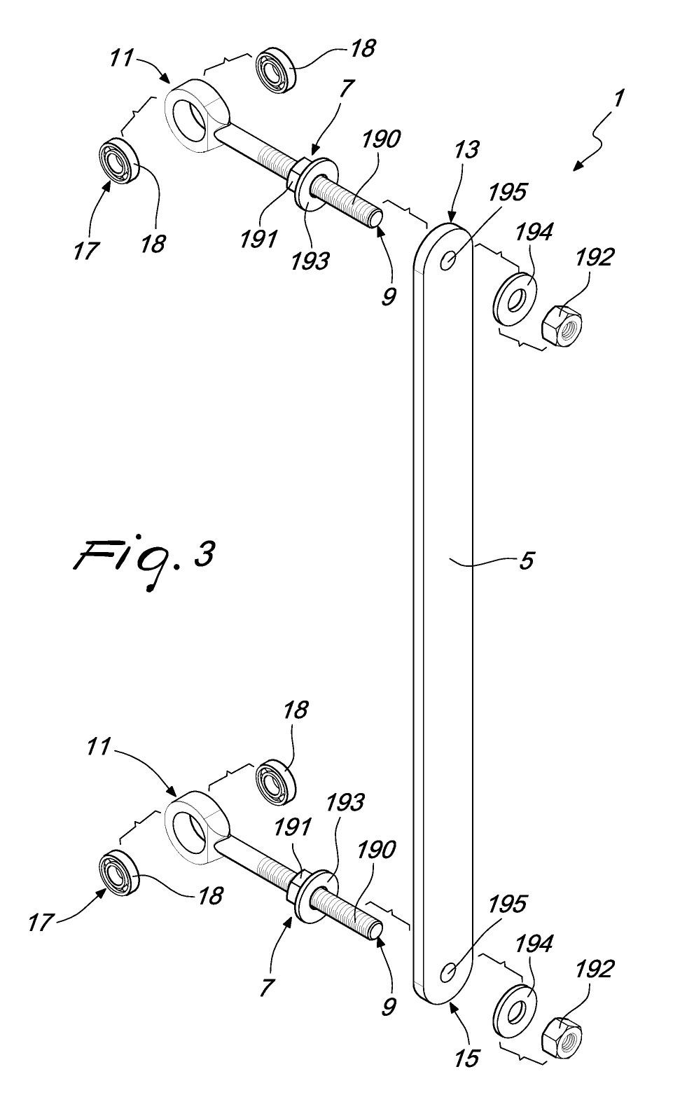

If the leaf spring 1 is adjustable in rigidity, the adjustment means 19 can comprise, as shown for example in FIGS. 1 to 3, a screw 190, preferably made of high-strength steel, which constitutes part of the rigid element 7 and which passes through by way of a hole 195 in the end 13, 15 of the elastic element 7, and a pair of nuts 191, 192 which are adapted to tighten the elastic element 5 in a given position with respect to the rigid element 7. Advantageously furthermore, between the nuts 191, 192 and the elastic element 5 there can also be washers 193, 194.

In this manner it is possible to modify, even independently with respect to the two rigid elements 7, the relative distance D of the elastic element 5 with respect to the straight line that joins the centers of rotation of the joints of the means for mating with a hinge-like coupling 17. By varying such distance D, or arm, it is possible to vary the bending torque on that elastic element 7, according to requirements.

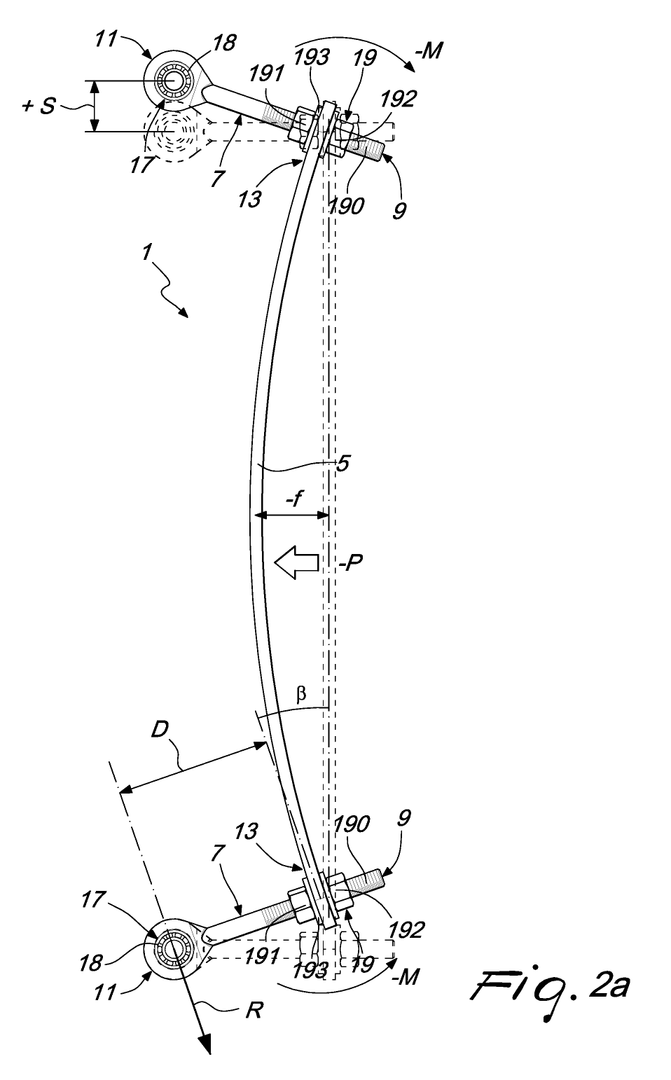

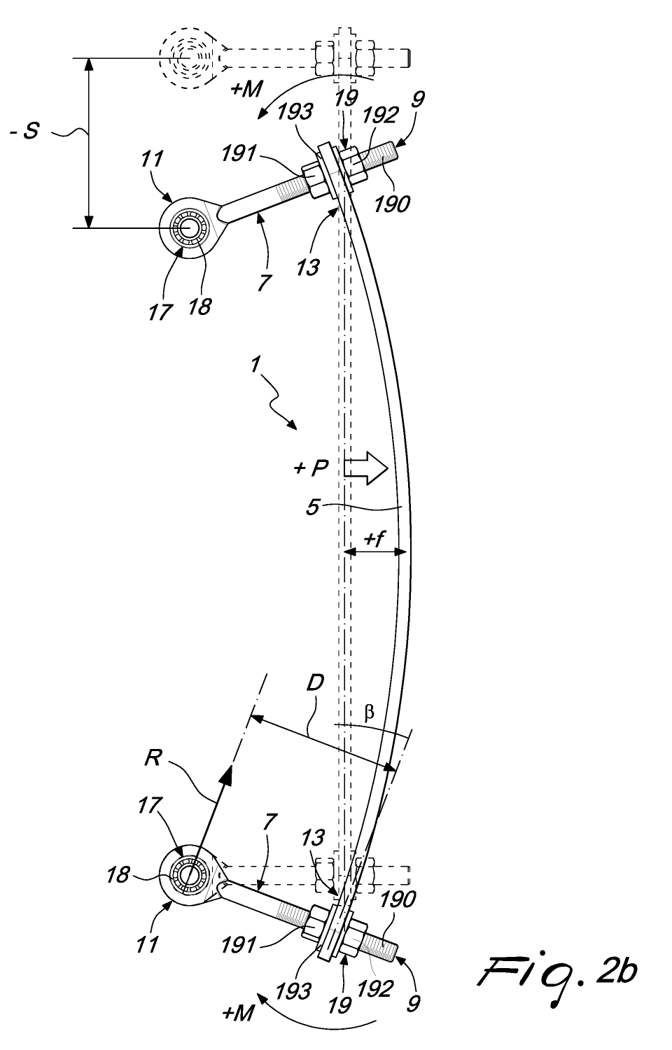

FIGS. 2a and 2b show the operating arrangement of the leaf spring 1, assuming it is isolated from a mechanical structure.

By applying, for example, a moment −M or +M of equal intensity, by way of the rotation of the rigid elements 7 around their centers of rotation, a bending is induced of the elastic element 5 with a deformation equal to −f or +f which corresponds to a translation +S or −S and, obviously, a rotation −M or +M of the rigid elements 7 around their centers of rotation.

Such rotation describes an angle β which is equal to the angle of tangency of the elastic deformation of the elastic element 5, so as to still define the direction of the reactions R along this directrix.

Such action corresponds to an arrangement where, for moments −M or +M that are for example identical, the shear stresses on the elastic element 5 become nil, while the distribution of the bending moment thereon is uniform and constant along its entire length.

Note for example, again with reference to FIGS. 2a and 2b, that such condition is also obtained by applying a transitional load, and therefore a non-coupled load, −P or +P on the elastic element 5.

It can also be seen that the travel, expressed as the sum of the translations of the centers of rotation of the rigid elements 7, is always equal to the deformation or camber −f or +f of the elastic element 5.

Furthermore, for two moments applied to the rotating ends of the rigid elements 7, with the direction of rotation reversed, a deformation (substantially S-shaped) and a different rigidity (halving the length of inflection, much higher) is induced in the elastic element 5 but, substantially, its operating arrangement does not change.

Advantageously, as illustrated in FIG. 10, the leaf spring 1 can be associated with an articulated mechanical structure 3, which can comprise a telescopic device 23 with a linear movement along its axis.

The two telescopes 230 and 231 can translate one inside the other, along its own longitudinal axis of extension, in both directions, as illustrated by way of example in FIGS. 10a and 10b. The leaf spring 1 is coupled to such telescopes 230 and 231 by way of the means 17 for coupling with a hinge-like coupling.

Advantageously, the leaf spring 1 can also be accommodated inside that telescopic device 23. Furthermore, there can be a plurality of leaf springs 1, arranged circularly around the telescopic device 23, in the quantity necessary to increase the resistance, for the same deformation.

The uses of telescopic cylinders cover many applications in all sectors of mechanical engineering. By using a particular type of composite material, as described above, the leaf spring 1 can be given characteristics of great reactivity or great damping. For the latter, the improvement is due to the great lightness of the system and, as a consequence, to its low inertia.

In some cases, such as for damping/suspension systems used, generally, in vehicles for road and rail, the damping characteristics of the present disclosure can avoid the use of damping systems, which are usually hydraulic or gas-operated and which are subject to overheating phenomena which condition their efficiency over time.

The present disclosure also enjoys advantages with respect to traditional suspension systems, with its capability to considerably reduce the weight of the suspended masses and consequently improve the driveability of the vehicles on which it is installed.

The leaf spring 1 can also provide a mechanical structure 3 which comprises a articulated polygon 25, 27.

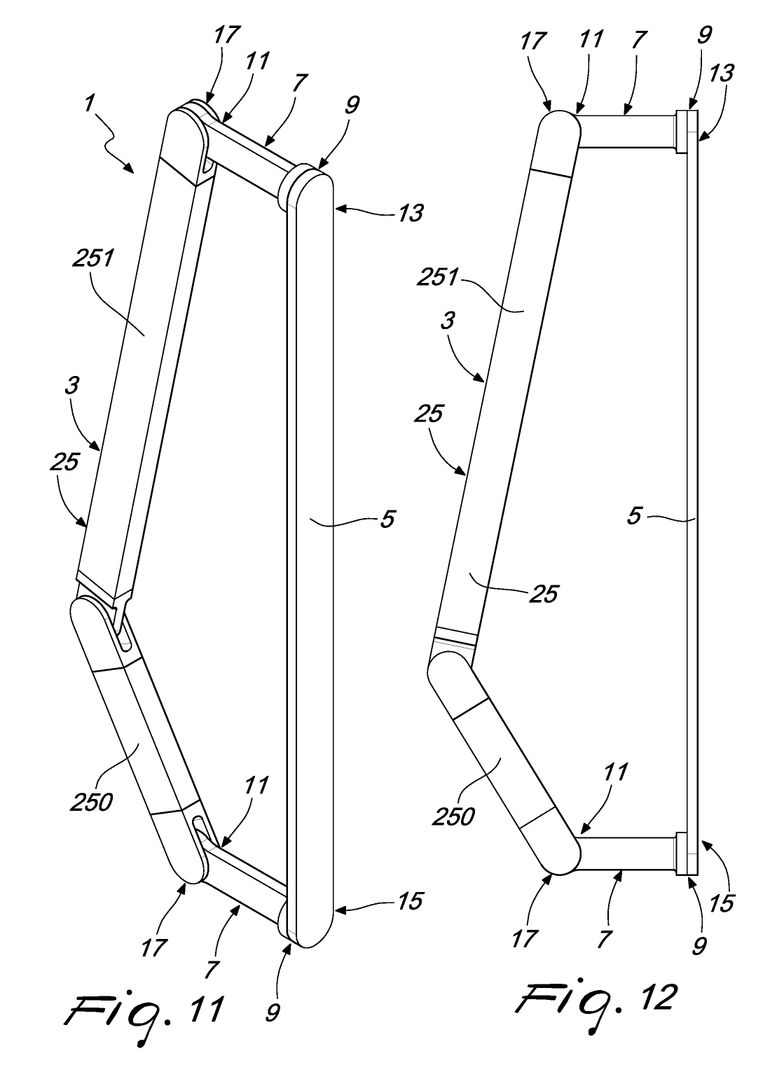

FIG. 11 shows the application of the leaf spring 1 to an articulated polygon 25, which is defined by two rigid rods 250 and 251, by the two rigid elements 7 and by the elastic element 5. The coupling means 17 between the rigid elements 7 and the rigid rods 250 and 251 comprise hinges that rotate about an axis perpendicular to the plane of deformation of the polygon 25. The two rigid rods 250 and 251 are also mutually connected by way of a hinge-like coupling.

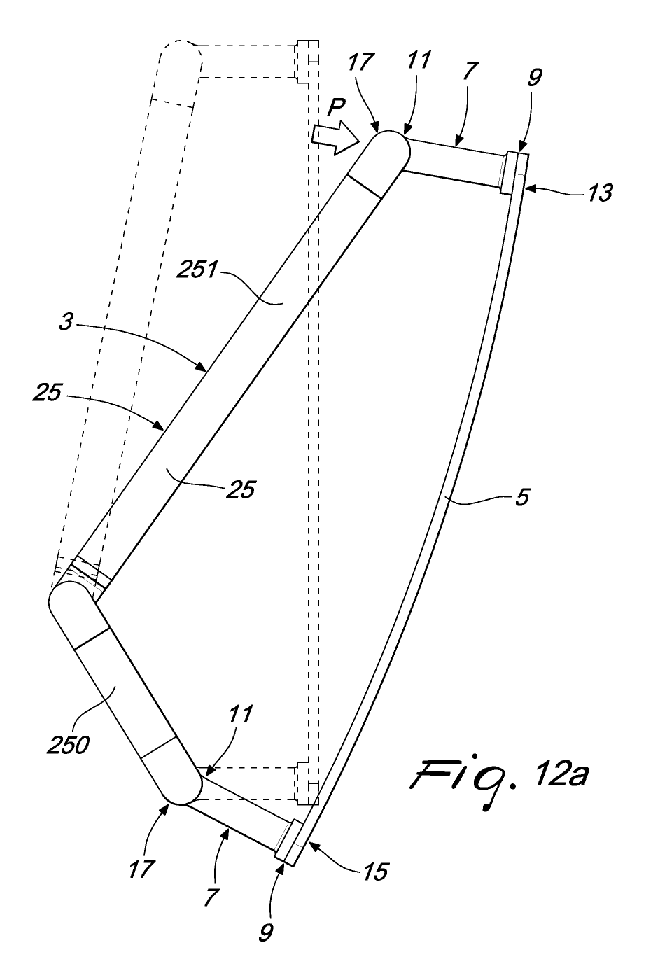

The articulated polygon 25 is capable of being deformed in a known and controlled manner, and, upon cessation of the action of the load P, owing to the elastic energy accumulated by the elastic element 5, it is capable of returning to its initial position and position of geometric equilibrium, as illustrated in FIG. 12a.

FIG. 12a is shows an operating arrangement of the leaf spring 1 with an articulated polygon 25, in which the rigid rod 250 is fixed.

By applying a force P to one end of the rigid rod 251, or along its extension, the articulated polygon 25 varies the relative positions of the sides that define it, and in particular the angles comprised between the aforementioned sides where a hinge-like coupling is present, according to the deformation imposed on the elastic element 5. The effect of the action of the load P translates in fact to a geometric deformation of the figure described, which is determined by the variations of the angles between the sides of the articulated polygon 25, and is absorbed and accumulated as elastic energy by the deformation of the elastic element.

The same behavior occurs, only with different values of the variations of the angles between the sides of the articulated polygon 25, with the change of sign of the deformation of the elastic element 5, by inverting the direction of the vector of the load P. In any case, upon cessation of such load P, independently of its direction, the system returns to the geometry of stability, returning the energy accumulated in the leaf spring 1.

Use of this solution is proposed in particular for articulated mechanical and biomechanical systems which need to render subservient, control, accumulate and return energy, for elements that are mutually connected, the operation of which is determined by an angular variation of such connection.

If the angles comprised between the rigid elements 7 and the respective rigid rods 250, 251 to which they are pivoted assume a value of 90°, then the state of equilibrium of the system is achieved with a geometry in which the rigid rods 250 and 251 are mutually aligned and are parallel to the elastic element 5.

The application of this geometry can also be for a pendulum with a mass suspended at an end thereof in order to even out its accelerations and decelerations upon inversion of the motion.

Another example is its applicability to hand cranks, pedal cranks and linkages in general, so as to render them elastic and as a consequence avoid the transit of dead centers in motions where application of the loads is non-continuous.

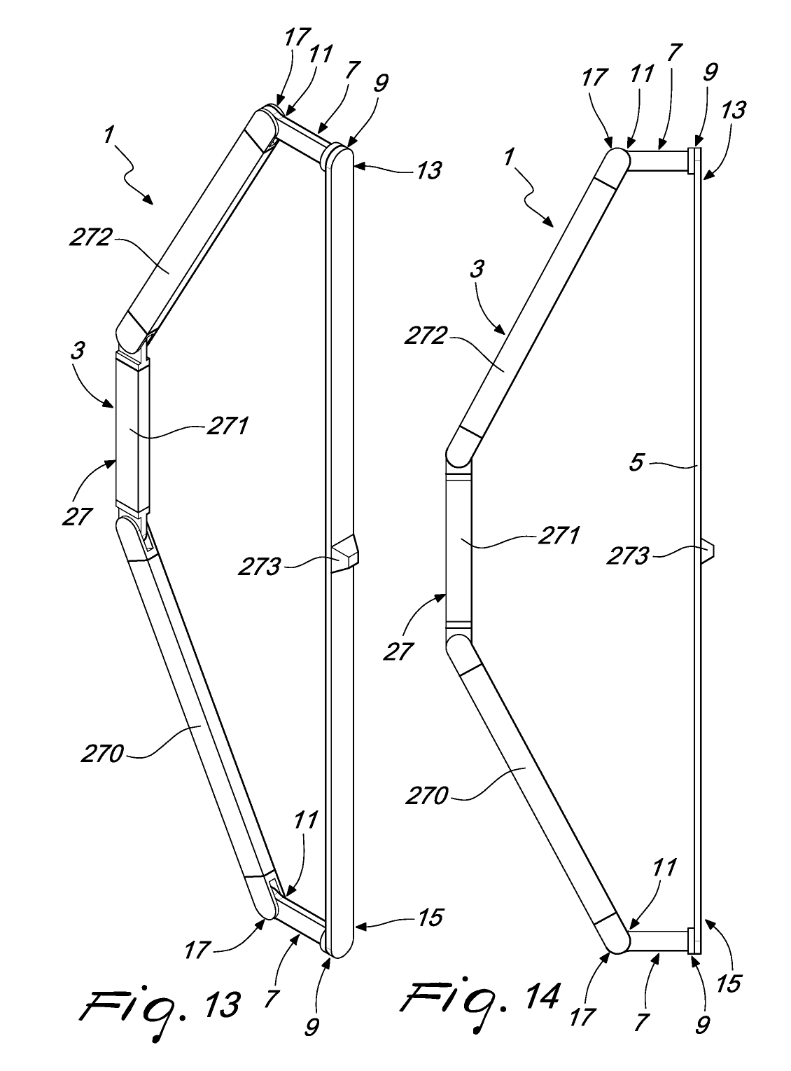

FIG. 13, which depicts a special case, shows the application of the leaf spring 1 to a different articulated polygon 27, which is made up of six sides in total, three of which are defined by mutually pivoted rigid rods 270, 271 and 272, where the rigid rod 271 is understood to be constrained in space, and three of which are defined respectively by the two rigid elements 7 and by the elastic element 5. The leaf spring 1 is constituted by the rigid elements 7, which are coupled by way of interlocking coupling to the ends 13 and 15 of the elastic element 5. In this case also, the application of a load produces the geometric deformation of the articulated polygon 27 as a function of the elastic deformation of the elastic element 5.

The six-sided articulated polygon 27 thus defined is capable of being deformed in a known and controlled manner, and, owing to the elastic energy accumulated by the elastic element 5, upon cessation of the action of the load P, applied for example at the protrusion 273 and which is transitory in nature and not coupled to the elastic element 5, it is capable of returning to its initial position and position of geometric equilibrium.

Use of such application is proposed, for example, for making a bow or a crossbow for shooting an arrow or bolt or, again, for the static accumulation of energy and its rapid release.

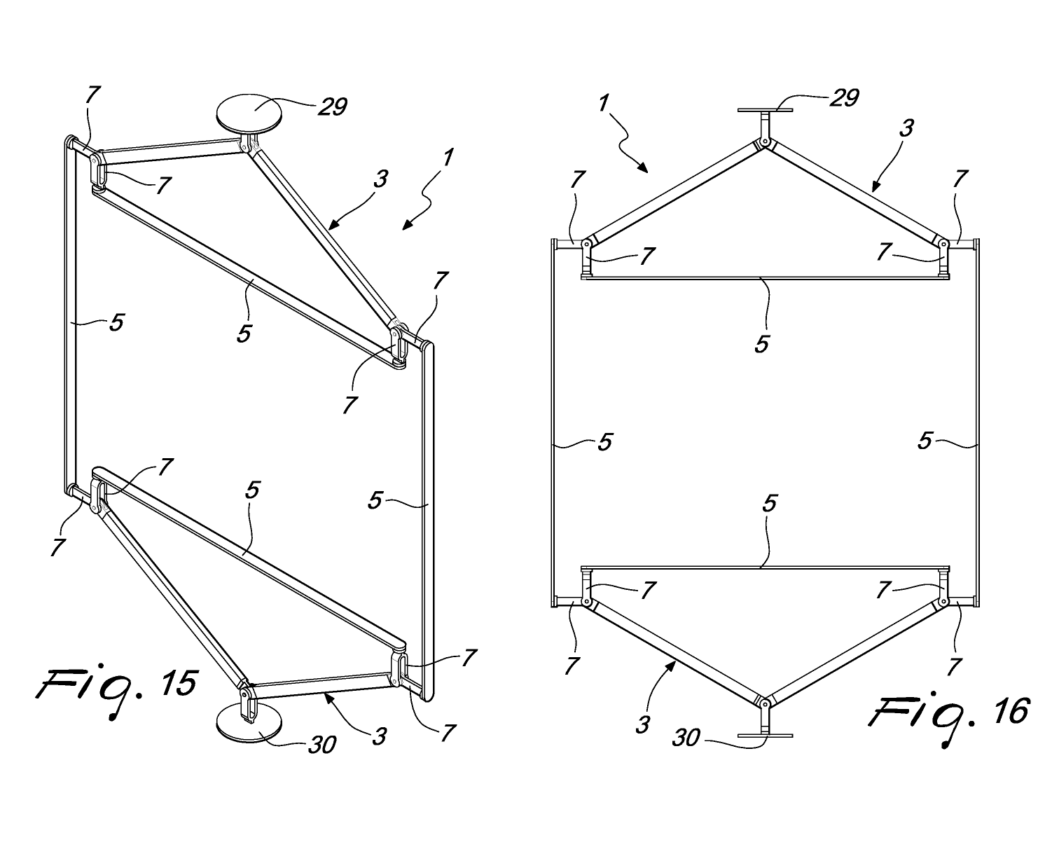

FIG. 15, which is substantially for demonstration purposes, shows a system that uses four leaf springs 1 which are conveniently connected to each other, to provide a complex articulated polygon. When a load is applied to the vertices 29 and 30 of the complex polygonal structure, the four elastic elements 5 bend elastically in a coordinated manner in order to accumulate and release energy.

As in the other examples of application shown, this also is capable of being deformed in a known and controlled manner, and, owing to the accumulated elastic energy of the elastic elements 5, upon cessation of the action of the load, it is capable of returning to its initial position and position of geometric equilibrium.

In practice it has been found that the disclosure fully achieves the set aim and objects. In particular, it has been seen that the leaf spring thus conceived makes it possible to overcome the drawbacks of the known art in terms of efficacy, simplicity of use, efficiency and applicability.

Another advantage of the leaf spring according to the disclosure is that, since it does not have loads or couplings applied directly on it, such loads or couplings being at most only transitory in nature, it is possible to have a mechanical arrangement with higher efficiency both in terms of the distribution of stresses and in terms of the values of the bending moments and, as a consequence, of the energy accumulated, thanks also to the use of a material that has a ratio of the bending breakage resistance (R) (in MPa) to the Young's modulus in bending (E) (in GPa) not less than 20, an index of a high energy accumulation in the form of mechanical deformation.

In the leaf spring according to the disclosure, the elastic deformations are not induced by loads or couplings that are fixed thereon, such loads or couplings being at most only transitory in nature, but only by way of a pair of rigid elements that are substantially perpendicular with respect to its preferential bending plane, and which are interlocked on one side to its ends and are provided on the other side with hinge-like couplings, the latter couplings being adapted to be connected to articulated mechanical structures, and with a rigidity that is at least five times higher than the rigidity of the elastic element relative to its preferential bending plane.

In such case the mechanical arrangement, referring to building science, is a beam that is subject to bending by way of two concentrated bending moments, the first in a rotating resting point which does not translate and the second, at the opposite end, in another rotating resting point which is free to translate in the Cartesian plane.

Such mechanical arrangement has great advantages over a beam coupled in the same way but with a load concentrated and/or distributed over its length: if the bending moments transmitted to the interlocked ends by the two longitudinal elements are identical, the shear stresses become nil while the distribution of the bending moment upon it is uniform and constant on its entire length, such as to be able to use, for example, a constant cross-section in order to optimize its behavior.

Such arrangement, furthermore, again irrespective of the loads and of the free lengths, and of the geometric inertia of the cross-section and of the Young's modulus that characterizes the material of which it is made, makes it possible to obtain bending moments of the order of the ratio ⅛. With respect therefore to the typical arrangement, for example, of a laminated leaf spring, it is no less than 6 times greater.

Another advantage of the leaf spring, according to the disclosure, is that it has adjustable rigidity. Another advantage of the leaf spring, according to the disclosure, is that it has bidirectional flexibility.

Another advantage of the leaf spring, according to the disclosure, is that it can be applied to any type of articulated mechanical structure.

Another advantage of the leaf spring, according to the disclosure, is that it takes advantage of bending stresses in a uniform and constant manner along all its length, with respect to the material of which it is made, given that it is common knowledge that bending stress is more advantageous than torsion stresses or tensile stresses.

Another advantage is the fact that the leaf spring, according to the disclosure, has greater resistance and higher inflection and, as a consequence, greater efficiency and greater value in terms of accumulated energy.

Another advantage is the fact that the leaf spring, according to the disclosure, has a very low weight, which favors damping and can limit the negative effect of suspended masses, such as in the suspensions of vehicles, which are usually very high.

Furthermore, the leaf spring thus conceived is easily and practically implemented and low cost. In fact, the arrangement described leads for example to the possibility of using a constant cross-section as can be derived from a flat sheet, and optimizing it.

The leaf spring thus conceived is susceptible of numerous modifications and variations. Moreover, all the details may be substituted by other, technically equivalent elements.

In practice the materials employed, provided they are compatible with the specific use, and the contingent dimensions and shapes, may be any according to requirements.

The content of Italian patent application no. MI2014A001851 (102014902304920), the priority of which is claimed in the present application, is incorporated as a reference.

1-9. (canceled)

10. A leaf spring comprises at least one longitudinally extended elastic element and a pair of rigid elements configured to be associated with an articulated mechanical structure, each one of said rigid elements being coupled rigidly, at a first end thereof, to a respective end of said elastic element and comprising, at a second end thereof, means of coupling to said articulated mechanical structure, which have a hinge-like coupling, and wherein said elastic element is not associated with any constraint or load between the two ends.

11. The leaf spring according to claim 10, wherein both of said rigid elements comprise means for mating with said articulated mechanical structure having hinge-like couplings arranged at an end opposite said first end, which rigidly couple the rigid elements to said elastic element.

12. The leaf spring according to claim 10, wherein said rigid elements each comprise means for adjusting the distance between the rotation axis of said means for mating with a hinge-like coupling and a point where said rigid element is rigidly coupled to said elastic element.

13. The leaf spring according to claim 10, wherein said elastic element is made of a material having a ratio between a bending breakage resistance, expressed in MPa, and a Young's stretch modulus in bending, expressed in GPa, not lower than 20.

14. The leaf spring according to claim 10, wherein each of said rigid elements is made of a material or in a shape having a bending rigidity, understood as the product of E×J, that is at least five times the bending rigidity of said elastic element relative to a bending plane thereof.

15. The leaf spring according to claim 11, wherein said means for mating with a hinge-like coupling are selected from the group constituted by ball bearing hinges, bushing hinges, barrel hinges, and spherical hinges.

16. The leaf spring according to claim 10, wherein said each of said rigid elements comprises a fork.

17. The leaf spring according to claim 10, further comprising an articulated mechanical structure having a telescopic device.

18. The leaf spring according to claim 10, further comprising an articulated mechanical structure having an articulated polygon.
